(19) United States
(12) Patent Application Publication
(10) Pub. No.: US 2017/0123129 A1
(43) Pub. Date: May 4, 2017

(54) LIQUID CRYSTAL DISPLAYS, BACKLIGHT MODULES, AND LIGHT GUIDLING PLATES

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventor: Yingbo ZHENG, Shenzhen, Guangdong (CN)

(73) Assignees: Shenzhen China Star Optoelectronics Technology Co., Ltd., Shenzhen, Guangdong (CN); WUHAN CHINA STAR OPTOELECTRONICS TECHNOLOGY CO., LTD, Wuhan, Hubei (CN)

(21) Appl. No.: 14/902,038

(22) PCT Filed: Apr. 30, 2015
(86) PCT No.: PCT/CN2015/078004

§ 371 Date: Jan. 14, 2017

(30) Foreign Application Priority Data
Apr. 24, 2015 (CN) 201510202027

(51) Int. Cl. F21V 8/00

(52) U.S. Cl. CPC G02B 6/002; G02B 6/0043; G02B 6/0091; G02B 6/0065

(57) ABSTRACT

A LCD, a backlight module, and a light guiding plate are disclosed. The light guiding plate includes an incident-light guiding portion, a light-emitting portion, and a connecting portion. The connecting portion connects the incident-light guiding portion and the light-emitting portion. The incident-light guiding portion is parallel to the light-emitting portion. The incident-light guiding portion and the connecting portion are arranged at one bending side of the connecting portion, and a lateral side of the light guiding plate is of a folded-back structure. The light guiding plate is configured to be of the folded-back structure. Compared to the edge-type backlight structure, the border and fixing components of the light source may be omitted, which contributes to narrow down the border, or even the border may be omitted. Compared to the direct-type backlight structure, the lens for scattering or uniforming the light beams may be omitted also, which realizes the thin design.

### BACKGROUND OF THE INVENTION

1. Field of the Invention

The present disclosure relates to liquid crystal display technology, and more particularly to a liquid crystal display (LCD), a backlight module, and the light guiding plate thereof.

2. Discussion of the Related Art

Large-scale LCDs have been developed with thinner and narrow border design. Usually, the backlight source of liquid crystal modules may include edge-type and direct-type, wherein the light source is arranged at a lateral side with respect to the edge-type.

Regarding the edge-type, as light bar is arranged at the lateral side of the liquid crystal module, the lights are uniformly distributed within the liquid crystal module. As the structure of the backlight source is thinner, it is difficult to implement narrow border design. Regarding the direct-type backlight source, a plurality of light sources are arranged in a bottom of the backlight source. Astigmatic lens are installed on the light source so as to mix the light beams within a space distance of an internal chamber of the backlight source. Thus, the narrow border design may be implemented when adopting the direct-type backlight source. However, it is still difficult to implement thin design.

### SUMMARY

The object of the invention is to provide a LCD, a backlight module, and the light guiding plate thereof. The proposed configuration may overcome the technical issues regarding the thin and narrow border issues as mentioned above.

In one aspect, alight guiding plate includes: an incident-light guiding portion, a light-emitting portion, and a connecting portion, the connecting portion connects the incident-light guiding portion and the light-emitting portion, the incident-light guiding portion is parallel to the light-emitting portion, a light-emitting surface is arranged at an outer surface of the light-emitting portion, the incident-light guiding portion and the connecting portion are arranged at one bending side of the connecting portion, and a lateral side of the light guiding plate is of a folded-back structure.

Wherein the light-emitting surface is of a structure having a plurality of dots.

Wherein the light guiding plate is made by synthetic resin.

Wherein a bending modulus of the light guiding plate is not less than 3000 MPa.

Wherein the light guiding plate is made by polycarbonate (PC) or Cyclic Olefin Copolymer (COC).

Wherein an extending length of the incident-light guiding portion is smaller than the extending length of the light-emitting portion along the lateral side.

Wherein the light guiding plate is made by optically dense medium.

In another aspect, a backlight module includes: a light source and a light guiding plate, the light guiding plate includes an incident-light guiding portion, a light-emitting portion, and a connecting portion, the connecting portion connects the incident-light guiding portion and the light-emitting portion, the incident-light guiding portion is parallel to the light-emitting portion, the incident-light guiding portion and the connecting portion are arranged at one bending side of the connecting portion, and a lateral side of the light guiding plate is of a folded-back structure, and the light source is arranged at an end surface of the incident-light guiding portion.

Wherein a light-emitting surface is arranged at an outer surface of the light-emitting portion.

Wherein the light guiding plate is made by optically dense medium.

Wherein the light-emitting surface is of a structure having a plurality of dots.

Wherein the light guiding plate is made by synthetic resin.

Wherein a bending modulus of the light guiding plate is not less than 3000 MPa.

Wherein the light guiding plate is made by polycarbonate (PC) or Cyclic Olefin Copolymer (COC).

Wherein an extending length of the incident-light guiding portion is smaller than the extending length of the light-emitting portion along the lateral side.

Wherein the light source is a LED lamp.

In one aspect, a liquid crystal display (LCD) includes the above backlight module.

In view of the above, the light guiding plate is configured to be of the folded-back structure. Compared to the edge-type backlight structure, the border and fixing components of the light source may be omitted, which contributes to narrow down the border, or even the border may be omitted. Compared to the direct-type backlight structure, the lens for scattering or uniforming the light beams may be omitted also, which realizes the thin design.

### BRIEF DESCRIPTION OF THE DRAWINGS

In order to more clearly illustrate the embodiments of the claimed invention, the following description of the drawings are only examples of some embodiments. For those of ordinary skills, other drawings may be easily conceived on the basis of the following drawings.

FIG. 1 is a schematic view of the light guiding plate engaging with a light source in accordance with one embodiment.

FIG. 2 is a front view of the light guiding plate of FIG. 1.

FIG. 3 is a schematic view showing the optical path of the Lambertian model of LEDs in accordance with one embodiment.

### DETAILED DESCRIPTION OF THE EMBODIMENTS

Embodiments of the invention will now be described more fully hereinafter with reference to the accompanying drawings, in which embodiments of the invention are shown.

FIG. 1 is a schematic view of the light guiding plate engaging with a light source in accordance with one embodiment. The light guiding plate 100 includes an incident-light guiding portion 110, a light-emitting portion 130, and a connecting portion 120.

Specifically, the connecting portion 120 connects the incident-light guiding portion 110 and the light-emitting portion 130. Preferably, the connecting portion 120 includes a smooth transition of an arc-shaped. The incident-light guiding portion 110 is parallel to the light-emitting portion 130 such that the incident-light guiding portion 110 and the connecting portion 120 are arranged at one bending side of the connecting portion 120. As such, the lateral side of the light guiding plate 100 is of a folded-back structure. In order to save the materials and space, an extending length of the incident-light guiding portion 110 is smaller than the extending length of the light-emitting portion 130 along the lateral side.

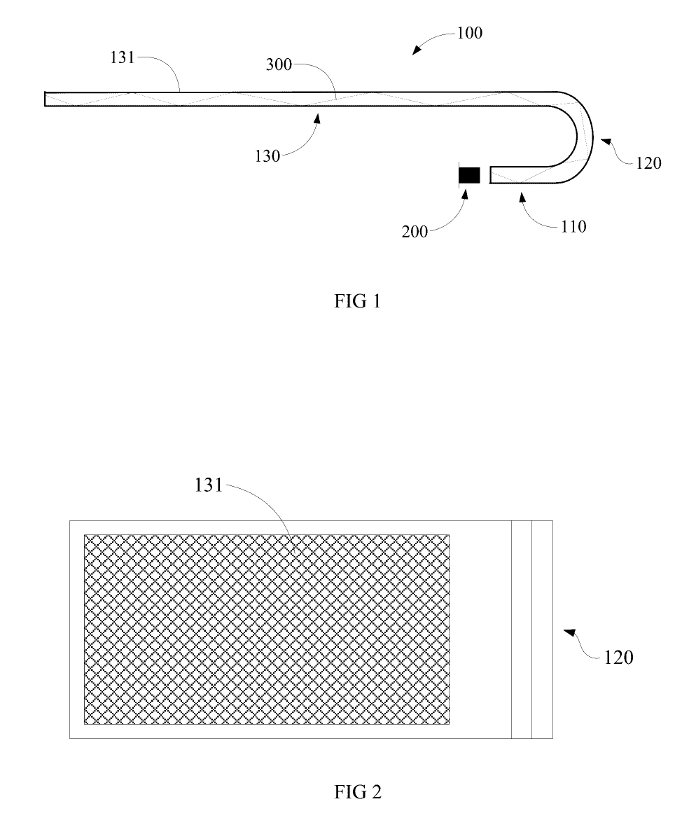

A light-emitting surface 131 is arranged at an outer surface of the light-emitting portion 130. FIG. 2 is a front view of the light guiding plate of FIG. 1. Referring to FIG. 2, the light-emitting surface 131 is of the structure having a plurality of dots such that the light beams may uniformly emit out from the light-emitting surface 131.

In the embodiment, the light guiding plate 100 may be made by optically dense medium having a greater reflective index. The greater the reflective index (η) of the optically dense medium is, the smaller the bending radius needed for the total-reflection light guide. Also, this configuration ensures that the thickness of optical path of the light guide can be thinner so as to realize the lightweight design. Wherein the relationship between the reflective index and the total reflection angle is: η=Sin 90/Sin C, wherein C represents the total-reflection angle of the lights. When the light beams are transmitted within the medium, a portion of the light beams may emit out, and the emitting threshold angle (C) may be calculated by: C=arcsin (1)/η.

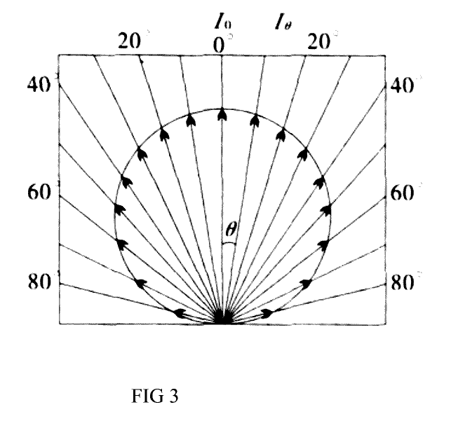

In the embodiment, the light source 200 preferably may be a LED lamp. The optical intensity of the LED lamp satisfies the Lambertian model, that is, I_{θ}=I₀ cos θ. FIG. 3 is a schematic view showing the optical path of the Lambertian model of LEDs in accordance with one embodiment. Wherein θ represents the light-emitting angle of the LED lamp, I_{θ} represents the optical intensity subject to different angles, and Io represents the lamp intensity of the LED lamp in a vertical direction. A central location of the bottom of FIG. 3 is the location of the LED lamp.

The incident light beams remaining within the light guiding plate 100 may be transmit to the light-emitting surface 131. The reference numeral 300 in FIG. 1 relates to the transmission path of the light beams within the light guiding plate 100. In addition, the light utilization rate may increase along with the increasement of η. Thus, by selecting the optically dense medium having a greater reflective index, the light utilization rate may be enhanced.

In addition, as the bending curvature of the light guiding plate 100 depends on the bending modulus of the materials. The greater the bending modulus results in the smaller the bending radius when the thickness of the light guiding plate 100 is the same. Basing on this rule, the material having greater bending modulus may be adopted to manufacture the light guiding plate 100, which may decrease the bending radius of the light guiding plate 100 to decrease the thickness of the backlight module such that the thin design may be realized.

The above configurations may contribute to the thinner backlight module. The following parameters regarding the synthetic-resin-photoconduction materials are obtained by experiments:

| Items | PMMA | PC | COC | PS |
|---|---|---|---|---|
| Bending | 1460 | 6450 | 3200 | 82.7 |
| modulus (MPa) | | | | |
| Reflective index | 1.49 | 1.52 | 1.54 | 1.59 |
| Light | 92% | 92% | 90% | 88% |
| transmittance | | | | |
| (%) | | | | |

Wherein PMMA relates to polymethylmethacrylate, PC relates to polycarbonate, COC relates to Cyclic Olefin Copolymer, and PS relates to styrenics. In view of the above table, the reflective indexes of the PMMA, PC, COC, and PS are larger, i.e., about 1.5, and are close to each other. The light transmittance of PMMA, PC, COC, and PS are about 90%, but the bending modulus of PMMA, PC, COC, and PS are quite different. In order to obtain smaller bending radius for the light guiding plate 100, the materials having greater bending modulus are needed. Preferably, the bending modulus is not less than 3000 MPa. In view of the above, the above materials including PC and COC in the above table are selected to manufacture the light guiding plate 100, which is capable of realizing the design of the backlight module. That is, the thin and narrow border design may be satisfied at the same time.

Referring to FIG. 1, a backlight module includes the light source 200 and the light guiding plate 100 in the above embodiment. The light source 200 is arranged at an end surface of the incident-light guiding portion 110 of the light guiding plate 100. The light source 200 may be a LED lamp, preferably, or other types of light sources.

In addition, in one embodiment, a LCD includes the backlight module in the above embodiment. The technical features of other structures of the LCD may be conceived by persons skilled in the art, and thus are omitted hereinafter.

In view of the above, the light guiding plate is configured to be of the folded-back structure and the light source is arranged at the end surface of the incident-light guiding portion 110 of the light guiding plate 100. Compared to the edge-type backlight structure, the border and fixing components of the light source may be omitted, which contributes to narrow down the border, or even the border may be omitted. On the other hand, compared to the direct-type backlight structure, the lens for scattering or uniforming the light beams may be omitted also, which realizes the thin design.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A light guiding plate, comprising:
an incident-light guiding portion, a light-emitting portion, and a connecting portion, the connecting portion connects the incident-light guiding portion and the light-emitting portion, the incident-light guiding portion is parallel to the light-emitting portion, a light-emitting surface is arranged at an outer surface of the light-emitting portion, the incident-light guiding portion and the connecting portion are arranged at one bending side of the connecting portion, and a lateral side of the light guiding plate is of a folded-back structure.

2. The light guiding plate as claimed in claim 1, wherein the light-emitting surface is of a structure having a plurality of dots.

3. The light guiding plate as claimed in claim 1, wherein the light guiding plate is made by synthetic resin.

4. The light guiding plate as claimed in claim 3, wherein a bending modulus of the light guiding plate is not less than 3000 MPa.

5. The light guiding plate as claimed in claim 4, wherein the light guiding plate is made by polycarbonate (PC) or Cyclic Olefin Copolymer (COC).

6. The light guiding plate as claimed in claim 1, wherein an extending length of the incident-light guiding portion is smaller than the extending length of the light-emitting portion along the lateral side.

7. The light guiding plate as claimed in claim 1, wherein the light guiding plate is made by optically dense medium.

8. A backlight module, comprising:
a light source and a light guiding plate, the light guiding plate comprises an incident-light guiding portion, a light-emitting portion, and a connecting portion, the connecting portion connects the incident-light guiding portion and the light-emitting portion, the incident-light guiding portion is parallel to the light-emitting portion, the incident-light guiding portion and the connecting portion are arranged at one bending side of the connecting portion, and a lateral side of the light guiding plate is of a folded-back structure, and the light source is arranged at an end surface of the incident-light guiding portion.

9. The backlight module as claimed in claim 8, wherein a light-emitting surface is arranged at an outer surface of the light-emitting portion.

10. The backlight module as claimed in claim 8, wherein the light guiding plate is made by optically dense medium.

11. The backlight module as claimed in claim 9, wherein the light-emitting surface is of a structure having a plurality of dots.

12. The backlight module as claimed in claim 10, wherein the light guiding plate is made by synthetic resin.

13. The backlight module as claimed in claim 12, wherein a bending modulus of the light guiding plate is not less than 3000 MPa.

14. The backlight module as claimed in claim 13, wherein the light guiding plate is made by polycarbonate (PC) or Cyclic Olefin Copolymer (COC).

15. The backlight module as claimed in claim 8, wherein an extending length of the incident-light guiding portion is smaller than the extending length of the light-emitting portion along the lateral side.

16. The backlight module as claimed in claim 8, wherein the light source is a LED lamp.

17. A liquid crystal display (LCD) comprises a backlight module as claimed in claim 8.

18. The liquid crystal display (LCD) as claimed in claim 17, wherein a light-emitting surface is arranged at an outer surface of the light-emitting portion.

19. The liquid crystal display (LCD) as claimed in claim 17, wherein the light guiding plate is made by optically dense medium.

20. The liquid crystal display (LCD) as claimed in claim 18, wherein the light-emitting surface is of a structure having a plurality of dots.
